(19) United States
(12) Patent Application Publication
(10) Pub. No.: US 2021/0388514 A1
(43) Pub. Date: Dec. 16, 2021

(54) ELECTRODE FOR OXYGEN EVOLVING, METHOD OF PREPARING THE ELECTRODE, AND OXYGEN GENERATING DEVICE INCLUDING THE ELECTRODE

(71) Applicants: Hyundai Motor Company, Seoul (KR); Kia Motors Corporation, Seoul (KR); Yonsei University, University - Industry Foundation (UIF), Seoul (KR)

(72) Inventors: Yunsu Lee, Uiwang (KR); Eunjik Lee, Uiwang (KR); Ji-Hoon Jang, Suwon (KR); Dongil Lee, Goyang (KR); Woojun Choi, Seoul (KR)

(21) Appl. No.: 17/038,812

(22) Filed: Sep. 30, 2020

(30) Foreign Application Priority Data
Jun. 15, 2020 (KR) 10-2020-0072317

(51) Int. Cl. C25B 11/04; C25B 11/03; C25B 9/06; C25B 1/04

(52) U.S. Cl. CPC C25B 11/0489; C25B 11/0405; C25B 1/04; C25B 11/035; C25B 9/06; C25B 11/0415

(57) ABSTRACT

Disclosed are, inter alia, an electrode for oxygen evolving, a method of preparing the electrode, and an oxygen generating device including the electrode. The electrode for oxygen evolving includes a metal nanocluster including a core formed of metal atoms and an organic thiol-containing ligand bound to a surface of the core, and a metal support to which the metal nanocluster is fixed.

According to various exemplary embodiments of the present invention, e.g., by using the electrode, a non-precious metal/non-carbon catalyst may be used as a catalyst for oxygen evolving, which is a half reaction of alkaline water electrolysis, oxygen evolving activity and high stability may be substantially improved, a catalyst usage amount may be minimized by increasing dispersibility of a catalyst in an electrode, and an efficiency of an oxygen evolving device may be increased by increasing a surface area of an electrode and decreasing electrolyte resistance.

### CROSS-REFERENCE TO RELATED APPLICATION

This application claims priority to and the benefit of Korean Patent Application No. 10-2020-0072317 filed in the Korean Intellectual Property Office on Jun. 15, 2020, the entire contents of which are incorporated herein by reference.

### TECHNICAL FIELD

The present invention relates to an electrode for oxygen evolving, a method of preparing the electrode, and an oxygen generating device including the electrode. The electrode may include a non-precious metal/non-carbon catalyst as a catalyst for oxygen evolving, which is a half reaction of alkaline water electrolysis. As such, oxygen evolving activity and high stability may be substantially improved, a catalyst usage amount may be minimized by increasing dispersibility of a catalyst in an electrode, and efficiency of an oxygen generating device may be increased by increasing a surface area of an electrode and decreasing electrolyte resistance.

### BACKGROUND

New and renewable energy development is accelerating to respond to fossil fuel depletion and climate change. Among them, alkaline water electrolysis, which consists of a hydrogen production reaction and an oxygen production reaction, is a core technology of the hydrogen economy, fuel cells, and artificial photosynthesis.

Relatively much studied hydrogen production technologies are now entering a maturity (commercialization) phase. On the other hand, an oxygen generating technology through water electrolysis has rather complicated mechanism, and much research thereon is needed.

Particularly, since overall efficiency of an alkaline water electrolysis device is determined by the oxygen evolving, which requires a relatively slow and large overvoltage, development of related technologies is urgent.

In the development of related technologies, since a cost of a catalytic electrode in the alkaline water electrolysis device accounts for about 49% of a total cost thereof, development of the catalytic electrode has become important, and for example, a platinum (Pt)-based having high activity in most energy-related electrochemical reactions such as hydrogen generation and oxygen reduction can have low oxygen generation activity.

Of currently studied oxygen evolving catalysts, a rubidium (Ru)-based catalyst has been used as a material having the highest activity, but it has poor stability under an alkaline condition. A relatively stable and highly active iridium (Ir)-based catalyst is used as a commercial oxygen evolving catalyst. However, the Ir-based catalyst may be limited in use because of limitations in price, reserves, and uniformity. Thus, a catalyst to replace it is required.

Moreover, stability of a non-precious metal catalyst is low in an acidic condition, while its stability problem may be overcome in an alkaline electrolytic condition. However, for fast electron transfer of the catalyst, when a carbon electrode or a carbon-based conductive material is mainly used as an electrode material, corrosion occurs under an oxygen evolving condition, resulting in poor long-term stability.

Therefore, there is a need to develop a non-carbon-based/non-precious metal-based catalyst electrode that may be stably driven under an alkaline water electrolysis condition.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided are an electrode for oxygen evolving that may use a non-precious metal/non-carbon catalyst as a catalyst for oxygen evolving, which is a half reaction of alkaline water electrolysis, may have excellent oxygen evolving activity and high stability, may minimize a catalyst usage amount by increasing dispersibility of a catalyst in an electrode, and may increase efficiency of an oxygen generating device by increasing a surface area of an electrode and decreasing electrolyte resistance.

In further preferred aspect, provided is a method of preparing an electrode for oxygen evolving and an oxygen generating device including an electrode for oxygen evolving.

In an aspect, provided is an electrode for oxygen evolving that may include: a metal nanocluster including i) a core including of metal atoms and ii) an organic thiol-containing ligand bound to a surface of the core; and a metal support to which the metal nanocluster is fixed.

The term “nanocluster” or “metal nanocluster” as used herein refers to a group of similar atoms (metal atoms) or compounds held or approximate to each other so as to make a substance in specific structure having a size (e.g., diameter, or a maximum distance of two end positions in the structure) of nanometer scale, for example, of about 0.1 to 100 nm, of about 0.1 to 50 nm, about 0.1 to 40 nm, about 0.1 to 30 nm, about 0.1 to 20 nm, about 0.1 to 10 nm, about 0.1 to 5 nm, about 0.5 nm to 2.0 nm, or about 1.0 nm to 2.0 nm. In certain embodiments, the metal nanocluster may be formed of metal-ligand complexes or coordination complexes, which may include one or more transition metal atoms and ligands or one or more complexing (chelating) agents. Preferred metal ions for the metal nanocluster may include Au, Cu, Ni, Fe, Co, Ag, and the like and preferred ligand may include sulfide or oxide form of hydrocarbons (e.g., aliphatic hydrocarbon or aromatic hydrocarbon) that may provide unpaired electrons to the metal atoms. The metal nanocluster may be represented by Chemical Formula 1 below.

Niₙ(SR)₂ₙ [Chemical Formula 1]

R is one or more selected from the group consisting of a substituted or unsubstituted C1 to C24 aliphatic hydrocarbon group, and a substituted or unsubstituted C6 to C20 aromatic hydrocarbon group, and n is an integer of 4 to 12.

The metal nanocluster may include one or more selected from the group consisting of Ni₄(SC₂H₄Ph)₈, Ni₅(SC₂H₄Ph)₁₀, Ni₆(SC₂H₄Ph)₁₂, Ni₄(SC₂H₅)₈, Ni₅(SC₂H₅)₁₀, Ni₆(SC₂H₅)₁₂, Ni₉(SPh)₁₈, Ni₁₁(SPh)₂₂, Ni₁₀(StBu)₁₀(etet)₁₀, and Ni₁₂(StBu)₁₂(etet)₁₂, wherein Ph is phenyl, StBu is tert-butyl thiolate, and etet is 2-ethylthioethanethiolate.

The metal support may suitably include a nickel foam.

The metal support may be acid-etched to remove an oxide of a surface thereof.

The electrode may include a compressed body in which a metal support to which the metal nanocluster is fixed is compressed to a thickness of about 1.0 mm or less.

In an aspect, provided is a method of preparing an electrode for oxygen evolving. The method may include: preparing a metal nanocluster including a core formed of metal atoms and an organic thiol-containing ligand bound to a surface of the core; and fixing the metal nanocluster to a metal support.

The method may further include removing a surface oxygen layer of the metal support by acid etching the metal support.

The acid may suitably include sulfuric acid, nitric acid, or a mixture thereof.

A concentration of the acid may be about 3 M or greater, and an acid etching treatment time may be within about 3 minutes.

The metal support after the acid etching treatment may have hydrophobicity in which a contact angle thereof may be increased by about 10% to 50% compared to that of the metal support before the acid etching treatment.

The method of preparing the electrode for the oxygen evolving may further include compressing the metal support to which the metal nanocluster is fixed, and the compressed metal support has a thickness of about 1.0 mm or less.

In an aspect, provided is an oxygen generating device, including: a working electrode including the electrode as described herein; a counter electrode; and an aqueous solution electrolyte.

The oxygen generating device may further include a reference electrode, wherein a distance between the working electrode and the reference electrode may be about 2 mm to 5 mm.

A concentration of the aqueous solution electrolyte may be about 1.0 M to 3.0 M.

An area of the working electrode may be about 0.03 cm² to 0.5 cm².

According to various exemplary embodiments of the present invention, a non-precious metal/non-carbon catalyst may be used in the electrode as a catalyst for oxygen evolving, which is a half reaction of alkaline water electrolysis, oxygen evolving activity and high stability of the electrode may be improved, a catalyst usage amount may be minimized by increasing dispersibility of a catalyst in an electrode, and efficiency of an oxygen generating device may be increased by increasing a surface area of an electrode and decreasing electrolyte resistance.

### BRIEF DESCRIPTION OF THE DRAWINGS

FIG. 1 shows an exemplary structure of an exemplary metal nanocluster represented by Ni₅(SC₂H₄Ph)₁₀.

FIG. 2 shows a photograph (left) of an exemplary nickel foam and a scanning electron microscope (SEM) photograph (right) of a microstructure of an exemplary nickel foam.

FIG. 3 shows an exemplary method of preparing an exemplary electrode for oxygen evolving.

FIG. 4 shows an exemplary oxygen generating device according to an exemplary embodiment of the present invention.

FIG. 5 shows a photograph of an exemplary PTLC result for separating Ni₅(SC₂H₄Ph)₁₀ in Preparation Example 1.

FIG. 6 shows a measurement result by electrospray ionization mass spectrometry of an exemplary Ni₅(SC₂H₄Ph)₁₀ prepared in Preparation Example 1.

FIG. 7 to FIG. 9 show graphs of XPS measurement results of an exemplary surface-treated nickel foam in Preparation Example 2.

FIG. 10 shows a result of measuring a contact angle of an exemplary surface-treated nickel foam in Preparation Example 2.

FIG. 11 shows a graph of a measurement result of an electrochemical surface area of an exemplary surface-treated nickel foam in Preparation Example 2.

FIG. 12 shows a graph of a result of measuring oxygen generating activity of an exemplary electrode for oxygen evolving in Experimental Example 3.

FIGS. 13 and 14 shows graphs of results of measuring stability of an exemplary electrode for oxygen evolving in Experimental Example 3 when oxygen is generated, by a cyclic current method and a constant voltage method.

FIG. 15 shows a graph of a result of measuring oxygen generating activity of an exemplary electrode for oxygen evolving compressed in Experimental Example 4.

FIG. 16 shows a graph of a result of measuring oxygen generating activity of an exemplary electrode for oxygen evolving when a distance between a working electrode and a reference electrode in Experimental Example 5 is minimized.

FIG. 17 shows a graph of results of measuring charge transfer resistance (R_{ct}) and electrolyte resistance (Rₛ) of an exemplary electrode for oxygen evolving when a distance between a working electrode and a reference electrode in Experimental Example 5 is minimized.

FIG. 18 shows a graph of a result of measuring oxygen generating activity of an exemplary electrode for oxygen evolving when a concentration of an electrolyte is increased in Experimental Example 5.

FIG. 19 shows a graph of results of measuring charge transfer resistance (R_{ct}) and electrolyte resistance (Rₛ) of an exemplary electrode for oxygen evolving when a concentration of an electrolyte is increased in Experimental Example 5.

FIG. 20 shows a graph of a result of measuring oxygen generating activity of an exemplary electrode for oxygen evolving when an area of an oxygen generating electrode is decreased in Experimental Example 5.

FIG. 21 shows a graph of results of measuring charge transfer resistance (R_{ct}) and electrolyte resistance (Rₛ) of an exemplary electrode for oxygen evolving when an area of an oxygen generating electrode is decreased in Experimental Example 5.

### DETAILED DESCRIPTION

Advantages and features of the present disclosure and methods of accomplishing the same may be understood more readily by reference to the following detailed description of preferred embodiments and the accompanying drawings. However, this disclosure may be embodied in many different forms and is not to be construed as limited to the embodiments set forth herein. Unless otherwise defined, all terms (including technical and scientific terms) used herein have the same meaning as commonly understood by one of ordinary skill in the art. Further, it will be understood that terms such as those defined in commonly used dictionaries should be interpreted as having a meaning that is consistent with their meaning in the context of the relevant art and the present disclosure, and will not be interpreted in an idealized or overly formal sense unless expressly so defined herein.

In the present specification, unless explicitly described to the contrary, the word “comprise” and variations such as “comprises” or “comprising” will be understood to imply the inclusion of stated elements but not the exclusion of any other elements.

Further, as used herein, the singular forms “a”, “an”, and “the” are intended to include the plural forms as well, unless the context clearly indicates otherwise.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Unless otherwise defined below, “substitution” means that hydrogen in a compound is substituted with one or more substituents selected from a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (—F, —Cl, —Br, or —I), a hydroxy group (—OH), a nitro group (—NO₂), a cyano group (—CN), an amino group (—NRR′ where R and R′ are independently of each other hydrogen or a C1 to C6 alkyl group), an azido group (—N₃), an amidino group (—C(═NH)NH₂), a hydrazino group (—NHNH₂), a hydrazono group (═N(NH₂)), an aldehyde group (—C(═O)H), a carbamoyl group (—C(O)NH₂), a thiol group (—SH), an ester group (—C(═O)OR, where R is a C1 to C6 alkyl group or a C6 to C12 aryl group), a carboxyl group (—COOH) or salt thereof (—C(═O)OM, where M is an organic or inorganic cation), a sulfonic acid group (—SO₃H) or salts thereof (—SO₃M, where M is an organic or inorganic cation), and a phosphoric acid group (—PO₃H₂) or salts thereof (—PO₃MH, or —PO₃M₂, where M is an organic or inorganic cation).

The term “aliphatic hydrocarbon group” as used herein refers to a straight or branched, saturated or unsaturated, chain alkyl group, for example C1-C30 carbons, C1-C24 carbons, or C1-C20 carbons.

The term “aromatic hydrocarbon group” as used herein refers to a C6 to C30 aryl group (e.g., phenyl, naphthyl, or anthracenyl) forming a ring structure.

The term “alicyclic hydrocarbon group” as used herein a C3 to C30 cycloalkyl group, a C3 to C30 cycloalkenyl group, or a C3 to C30 cycloalkynyl group, and the carbons atoms forms a cyclic or ring structure.

The electrode for oxygen evolving may include a metal nanocluster and a metal support to which the metal nanocluster is fixed.

The metal nanocluster may include dozens or fewer metal atoms, and may have a transition form between atoms and nanoparticles, such that the metal nanocluster may have completely different electrical, magnetic, optical, and electrochemical properties from an existing metal nanoparticle or semiconductor quantum dot. In addition, the metal nanocluster may control a structure and composition of particles at an atomic level, and particularly, it may have high uniformity at a molecular level and high stability at a metal level, and thus may be applied as an electrochemical catalyst with high reaction selectivity.

Particularly, the metal nanocluster may include i) a core including or formed of metal atoms and ii) an organic thiol-containing ligand bound to a surface of the core. For example, the metal nanocluster may include a core formed of metal atoms and an organic thiol-containing (SR) ligand that protects its surroundings like a shell.

The metal nanocluster may suitably include a non-precious metal/non-carbon catalyst, and the metal atom forming the core may suitably include a transition metal, for example, nickel.

Suitably thiol-containing ligands may comprise one or more thiol moieties (e.g. —SH— or >S) and further may suitably comprise one or more saturated or unsaturated carbon atoms, e.g.

C1-20 or C1-12 or C1-6 group. Preferrred thiol-containing ligands may comprise 1, 2 or 3 sulfur atoms, more preferably 1 or 2 sulfur atoms. Suitable thiol-containing ligands may be saturated or unsaturated and suitably may comprise phenyl or other aromatic groups. Suitable thiol-containing ligands may be saturated or unsaturated and suitably may comprise phenyl or other aromatic groups. Suitable thiol-containing ligands also may be saturated and comprise for example 1-20 or 102 or 1-6 saturated carbons and 1, 2 or 3 sulfur atoms, more typically 1 or 2 sulfur atoms.

Particularly preferred organic thiol-containing ligand may include one or more selected from the group consisting of ethanethiol, phenylethanethiol, phenylthiol, tert-butyl thiol, and 2-ethylthioethanethiol.

As an example, the metal nanocluster may be represented by Chemical Formula 1 below.

Niₙ(SR)₂ₙ [Chemical Formula 1]

In Chemical Formula 1, R may be one or more selected from the group consisting of a C1 to C24 substituted or unsubstituted aliphatic hydrocarbon group and a C6 to C20 substituted or unsubstituted aromatic hydrocarbon group, and n may be an integer of 4 to 12.

For example, the metal nanocluster may include one or more selected from the group consisting of Ni₄(SC₂H₄Ph)₈, Ni₅(SC₂H₄Ph)₁₀, Ni₆(SC₂H₄Ph)₁₂, Ni₄(SC₂H₅)₈, Ni₅(SC₂H₅)₁₀, Ni₆(SC₂H₅)₁₂, Ni₉(SPh)₁₈, Niₙ(SPh)₂₂, Ni₁₀(StBu)₁₀(etet)₁₀, and Ni₁₂(StBu)₁₂(etet)₁₂, where Ph is phenyl, StBu is tert-butyl thiolate, and etet is 2-ethylthioethanethiolate.

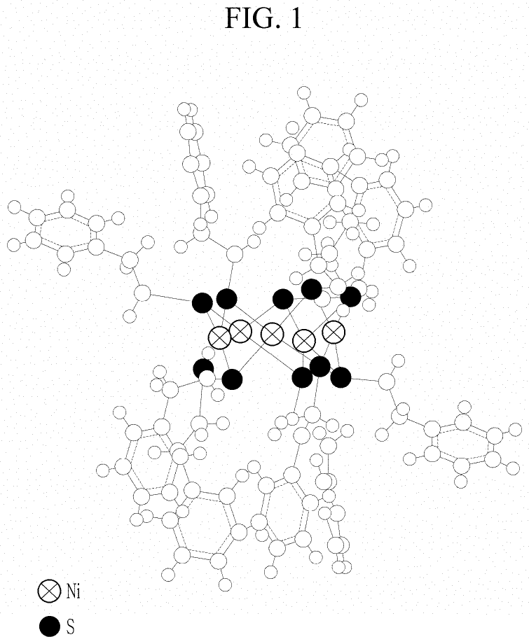

FIG. 1 illustrates a schematic diagram of a structure of a metal nanocluster represented by Ni₅(SC₂H₄Ph)₁₀.

As shown in FIG. 1, the metal nanocluster may include a core composed of five nickel atoms and an organic thiol-containing ligand derived from phenylethanethiol (PET), which protects its surroundings like a shell, and the metal atom and the organic thiol-containing ligand are bound by a sulfur (S) atom of the thiol. An organic thiol-containing ligand protective layer may provide unique high stability of the metal nanocluster.

A size of the metal nanocluster may be about 0.5 nm to 2.0 nm, and for example, about 1.0 nm to 2.0 nm. When the size of the metal nanocluster is less than about 0.5 nm, uniformity thereof may be decreased and the metal nanocluster may be unstable, and when the size of the metal nanocluster is greater than about 2.0 nm, unique molecular properties of the metal nanocluster may be lost and it may behave like a metal nanoparticle.

Meanwhile, a highly active catalyst for efficient oxygen evolving may be important, but it is also important to select an electrode material having high stability and low resistance and an electrode in which a catalyst is uniformly dispersed is also important. Thus, the electrode for oxygen evolving includes a metal support to which the metal nanocluster is fixed.

As a material of the metal support, aluminum (Al), nickel (Ni), iron (Fe), titanium (Ti), stainless steel, or the like may be suitably used, and the metal support may have a foil, plate, mesh (or grid), or foam (or sponge) shape. For example, the metal support may be a nickel foam.

Particularly, the metal support may have a porous structure such as foam, and in this case, porosity of the metal support may be about 90% to 97%, for example about 95% to 96%.

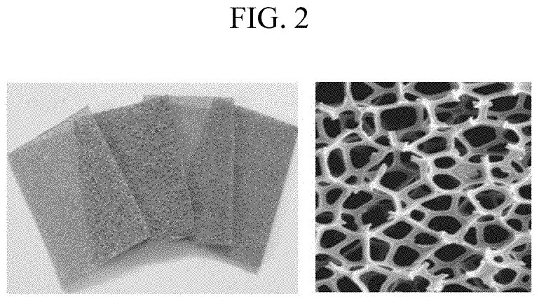

FIG. 2 illustrates a photograph (left) of a nickel foam and a scanning electron microscope (SEM) photograph (right) of a microstructure of the nickel foam. As shown in FIG. 2, since the nickel foam may have a large surface area and high stability in an oxidizing environment, it is suitable as an electrode material for alkaline water electrolysis.

Meanwhile, in order to improve dispersibility of the metal nanoclusters, a surface oxygen layer of the metal support may be removed by acid etching. For example, when the metal support is a nickel foam, a metal oxide (NiO, Ni₂O₃, or the like) on the surface of the metal support may be removed, and a metal or metal sulfide (Ni, NiS, Ni₂S₃, and the like) may be included therein.

As the oxygen layer on the surface of the metal support is removed by the acid etching treatment, the metal support after the acid etching treatment may have relative hydrophobicity compared to the metal support before the acid etching treatment, thereby improving the dispersibility of the metal nanoclusters. For example, the nickel foam before the acid etching treatment may have a contact angle of about 40 to 70 degrees, the nickel foam after the acid etching treatment may have a contact angle of about 70 degrees to 150 degrees, and the nickel foam after the acid etching treatment may have hydrophobicity in which the contact angle is increased by about 10% to 50% compared to that of the nickel foam before the acid etching treatment.

The electrode for oxygen evolving may include a compressed body in which a metal support has a fixed metal nanocluster compressed to have a thickness of about 1.0 mm or less, for example, about 0.3 mm to 1.0 mm. In addition, the electrode for the oxygen evolving may correspond to one in which a plurality of the compressed bodies are stacked, for example, 1 to 10 compressed bodies may be stacked. Thus, the surface area of the electrode for oxygen evolving may be increased, and the oxygen generation activity may be further improved.

A method of preparing an electrode for oxygen evolving according to an exemplary embodiment of the present invention includes preparing a metal nanocluster and fixing the metal nanocluster to a metal support.

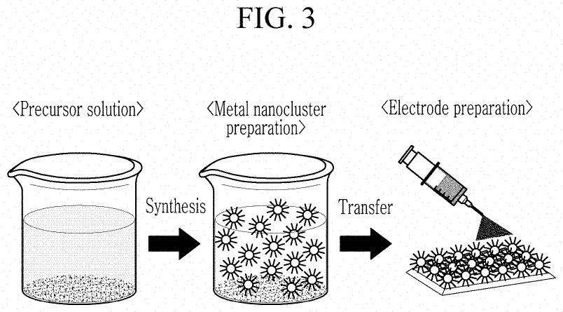

FIG. 3 illustrates a schematic diagram of an exemplary method of preparing an exemplary electrode for oxygen evolving. Hereinafter, a method of preparing an electrode for oxygen evolving will be described in detail with reference to FIG. 3.

First, a metal nanocluster including a core formed of metal atoms and an organic thiol-containing ligand bound to a surface of the core may be prepared.

The metal nanocluster may be prepared by adding an organic thiol-containing ligand to a solution containing a metal precursor, and then introducing a reducing agent thereto and reacting therewith.

For example, when the metal is nickel and the organic thiol-containing ligand is phenylethanethiol, a metal precursor such as Ni(NO₃)₂ or NiCl₂ may be added to a solvent such as n-propanol or 2-propanol to prepare a solution containing the metal precursor. Preferably, a concentration of the metal precursor may be 1 mM or less.

The organic thiol-containing ligand may be added drop by drop to the solution containing the metal precursor for 2 minutes or greater. After dropwise adding the organic thiol-containing ligand, one of reducing agents selected from the group consisting of triethylamine, NaBH₄, CO, and a mixture thereof may be added.

After the reducing agent is added, it is reduced for 12 hours or greater and 24 hours or less. Alternatively, reduction for 24 hours or greater may be conducted. When the reduction time is too short or long, a final yield of the metal nanoclusters may decrease.

Ni₄(SC₂H₄Ph)₈, Ni₅(SC₂H₄Ph)₁₀, and Ni₆(SC₂H₄Ph)₁₂ may be mixed in the mixed solution of the prepared metal nanoclusters, and for their separation, preparative thin layer chromatography (PTLC) may be used.

After dissolving and purifying the final product in toluene, metal nanoclusters may be obtained by adding ethanol to the solution to form crystals.

Next, an electrode for oxygen evolving is prepared by fixing the prepared metal nanocluster to a metal support.

As a method of fixing the metal nanocluster to the metal support, a method of dissolving the prepared metal nanocluster in a solution and then dripping the solution onto the metal support may be used. Through this method, a metal nanocluster may be deposited as a single layer on the metal support.

However, the present invention is not limited thereto, and any conventional method of supporting a catalyst on a support may be used. For example, a metal support may be immersed in a solution containing a metal nanocluster, or various coating methods may be used.

Meanwhile, in order to improve dispersibility of the metal nanoclusters, a surface treatment step of removing a surface oxygen layer of the metal support by acid etching may be further included.

Particularly, in the acid etching, a metal oxide (NiO or Ni₂O₃) on the surface of the metal support may be removed by etching the metal support using sulfuric acid, nitric acid, or a mixture thereof, and it may include a metal or a metal sulfide (Ni, NiS, or Ni₂S₃).

The metal support after the acid etching treatment may have hydrophobicity in which the contact angle may be increased by about 10% to 50% compared to the metal support before the acid etching treatment. In this case, the dispersibility of the hydrophobic metal nanoclusters on the metal support may be further improved. For example, a nickel foam before the acid etching treatment may have a contact angle of about 40 degrees to 70 degrees, and a nickel foam after the acid etching treatment may have a contact angle of about 70 degrees to 150 degrees.

In the acid etching, a concentration of the acid may be about 3 M or greater, for example, about 3 M to 18 M, and a treatment time thereof may be within about 3 minutes, for example, 1 minute to 2 minutes. When the concentration of the acid is less than 3 M, sufficient etching may not occur, and when the treatment time is greater than about 3 minutes, the nickel foam may melt.

Impurities remaining on the surface of the surface-treated metal support may be removed by using, for example, an ultrasonic disperser in a distilled water and ethanol solution, and the metal support from which impurities are removed may be stored in a toluene solution in which oxygen is removed to minimize air contact.

Alternatively, the method of preparing the electrode for oxygen evolving may further include compressing the metal support to which the metal nanocluster is fixed to a thickness of about 1.0 mm or less, for example, about 0.3 mm to 1.0 mm, and may further include stacking a plurality of metal supports to which the compressed metal nanoclusters are fixed. Thus, the surface area of the electrode for oxygen evolving may be increased, and the oxygen generation activity may be further improved.

An oxygen generating device according to an exemplary embodiment of the present invention includes a working electrode, a counter electrode, and an aqueous solution electrolyte.

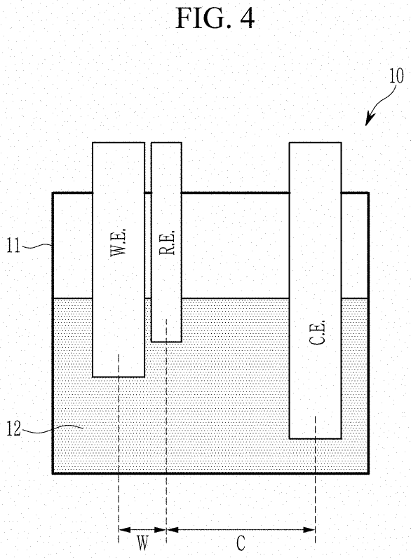

FIG. 4 illustrates a schematic diagram of an exemplary oxygen generating device according to an exemplary embodiment of the present invention. Hereinafter, the oxygen generating device will be described in detail with reference to FIG. 4.

An oxygen generating device 10 includes a container 11, an aqueous solution electrolyte 12 filled in the container 11, and a working electrode W.E., a counter electrode C.E., and optionally a reference electrode R.E. installed in the container 11.

The aqueous solution electrolyte 12 may be a source of water used for water decomposition oxygen evolving, and it includes water and OH⁻, K⁺, and the like. The aqueous solution electrolyte may have a concentration of about 0.1 M to 6.0 M, for example, about 1.0 M to 3.0 M. When the concentration of the aqueous solution electrolyte is less than about 0.1 M, resistance of the solution may be high, and when it is greater than about 6.0 M, a catalyst may be unstable or the electrolyte may precipitate.

The working electrode W.E. includes the electrode for oxygen evolving according to exemplary embodiments of the present invention. Since the description of the electrode for oxygen evolving is the same as above, repeated description is omitted.

The counter electrode C.E. may include one selected from a group consisting of platinum, nickel, carbon, and iron. For example, a platinum gauze may be used as the counter electrode C.E.

The reference electrode R.E. may include one selected from the group consisting of Ag/AgCl, a saturated calomel electrode (SCE), Hg/HgO, and Hg/Hg₂SO₄. For example, Ag/AgCl(3 M NaCl) may be used as the reference electrode R.E.

A distance between the working electrode and the reference electrode may be about 2 mm to 10 mm, for example, about 2 mm to 5 mm. In addition, resistance may be caused by oxygen bubbles generated when the distance between the working electrode and the reference electrode is less than about 2 mm, and when it is greater than about 10 mm, resistance of an entire reaction cell may be increased.

In this case, an area of the working electrode may be about 0.03 cm² to 6.25 cm², for example, about 0.03 cm² to 0.5 cm². When the area of the working electrode is less than about 0.03 cm², a generated current may be too small, and when it is greater than about 6.25 cm², the reaction solution may be rapidly consumed.

According various exemplary embodiments, a non-precious metal-based or non-carbon-based metal nanocluster may be used for oxygen evolving, which is a half reaction of alkaline water electrolysis. By using the catalyst preparing method of the present invention, it is possible to prepare a metal nanocluster with high efficiency and high stability (size purity of 95% or greater), it is possible to increase the dispersibility of the catalyst in the electrode and minimize the catalyst usage (e.g., −4 μg/cm²), and by increasing the efficiency of the oxygen generating device through increasing the surface area of the electrode and decreasing the electrolyte resistance, it is possible to obtain the activity of the world's highest level of oxygen evolving (e.g., 1.3 A/cm² @ 1.60 V) and high stability (e.g., 400 h or greater).

### Example

### Preparation Example 1: Preparation of Metal Nanocluster

200 mg Ni(NO₃)₂(0.7 mmol) was added to 12 mL of n-propanol and stirred for 20 minutes to prepare a solution containing a metal precursor.

1.4 mmol of phenylethanethiol as an organic thiol-containing ligand was added dropwise for 2 minutes to the solution containing the metal precursor. After adding the organic thiol-containing ligand and stirring for 15 minutes, triethylamine (3.6 mmol) was added as a reducing agent and reduced for 24 hours.

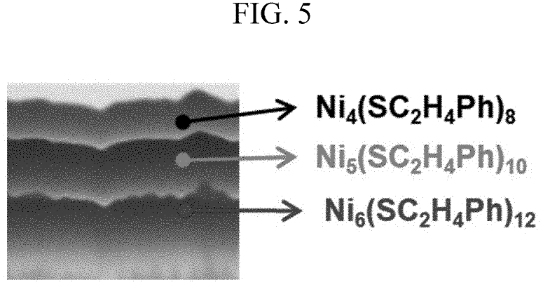

For separation of the prepared nickel nanocluster mixture solution (Ni₄(SC₂H₄Ph)₈, Ni₅(SC₂H₄Ph)₁₀, or Ni₆(SC₂H₄Ph)₁₂), as shown in FIG. 5, a preparative thin layer chromatography (PTLC) was used. A developing solution was developed for 10 minutes at a ratio of dichloromethane:hexane=1:1 to 1:3 (v/v).

A final product (Ni₅(SC₂H₄Ph)₁₀) was dissolved in toluene and then ethanol corresponding to 3 times of the solution was added to form crystals. Specifically, after the nickel nanocluster, toluene, and ethanol solutions were completely mixed, crystal formation was slowly performed at a low temperature of 4 degrees Celsius or less for 12 hours. To obtain a high purity nickel nanocluster, three or more repeated crystallization processes were performed.

### Experimental Example 1: Measurement of Properties of Metal Nanocluster

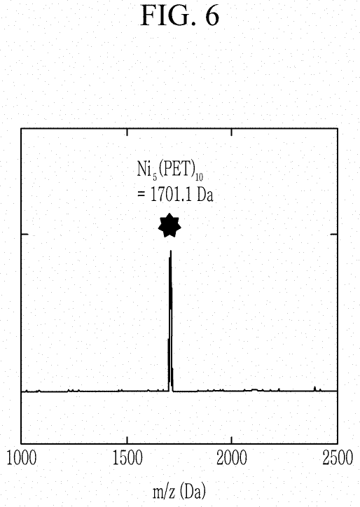

The synthesized Ni₅(SC₂H₄Ph)₁₀ was confirmed through electrospray ionization mass spectrometry (ESI-MS), and the results are shown in FIG. 6.

As shown in FIG. 6, size purity of Ni₅(SC₂H₄Ph)₁₀ separated through the PTLC was 95% or more, confirming that high purity nickel nanoclusters were synthesized.

Accordingly, it is possible to mass-produce high purity nickel nanoclusters with increasing precursors and reaction solutions.

### Preparation Example 2: Preparation of Electrode for Oxygen Evolving

In order to form a stable Ni₅(SC₂H₄Ph)₁₀/nickel foam electrode, first, the surface oxygen layer of the nickel foam was removed by etching with sulfuric acid and nitric acid, respectively. Specifically, a concentration of the sulfuric acid and nitric acid was 3 M, and each treatment time was 3 minutes.

Impurities remaining on the surface of the surface-treated nickel foam were removed in the distilled water and ethanol solution for 20 minutes each using an ultrasonic disperser. The nickel foam from which impurities were removed was kept in a toluene solution from which oxygen was removed to minimize air contact.

Meanwhile, the Ni₅(SC₂H₄Ph)₁₀ synthesized in Preparation Example 1 was dissolved in a tetrahydrofuran solution, and then the solution was added dropwise onto a surface-treated nickel foam to form an electrode.

The Ni₅(SC₂H₄Ph)₁₀ with high dispersion was capable of catalytic activity with a very small amount (about 4 μg) of deposition.

### Experimental Example 2: Characteristic Measurement of Surface-Treated Metal Support

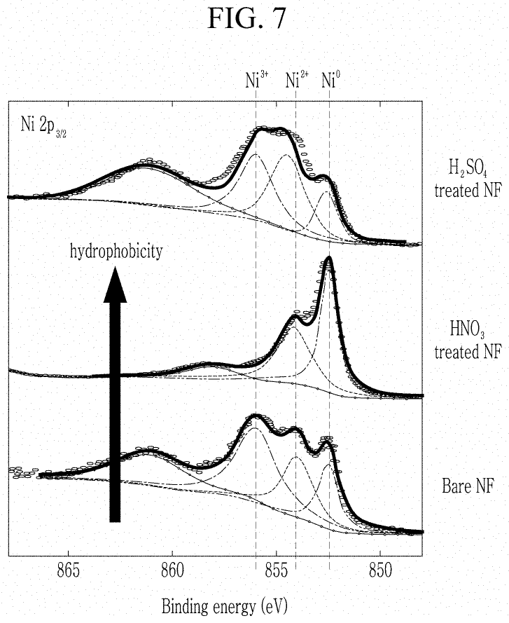

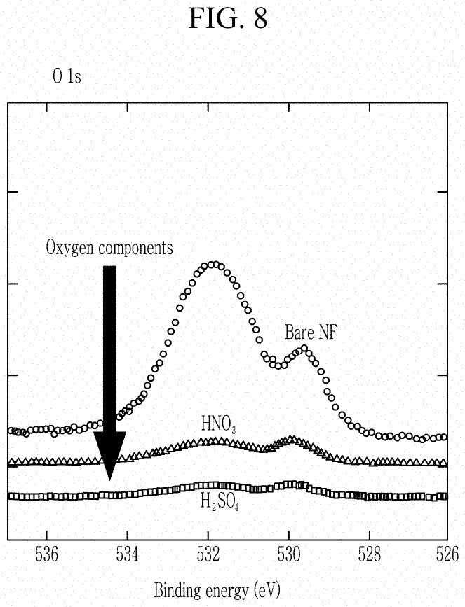

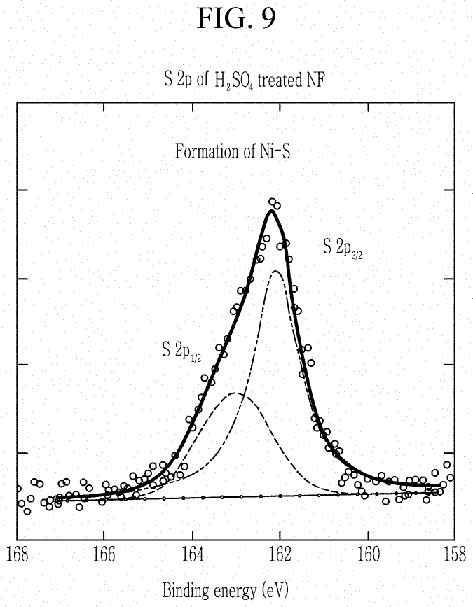

The chemical properties of the surface-treated nickel foam in Preparation Example 2 were confirmed by X-ray photoelectron spectroscopy (XPS), and the results are shown in FIG. 7 to FIG. 9.

In FIG. 7 to FIG. 9, “H₂SO₄ treated NF” refers to nickel foam surface-treated with sulfuric acid, “HNO₃ “treated NF” refers to nickel foam surface-treated with nitric acid, and “Bare NF” refers to nickel foam not surface-treated with the sulfuric acid or nitric acid.

As shown in FIG. 7 to FIG. 9, in all of the nickel foam surface-treated with the sulfuric acid or nitric acid, the surface oxygen layer rapidly decreased. That is, as the oxygen layer existing in a form of NiO or Ni₂O₃ on the surface of the nickel foam was removed, as it was changed to a form of Ni, NiS, and Ni₂S₃.

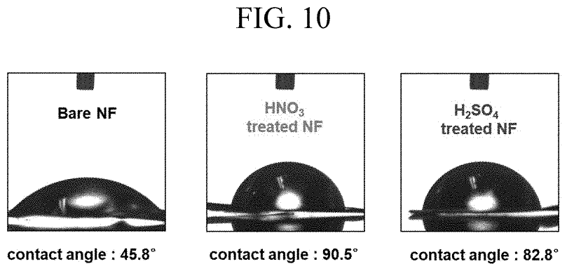

In addition, the physical properties of the surface-treated nickel foam were confirmed through a contact angle meter, and the results are shown in FIG. 10.

In FIG. 10, “H₂SO₄ treated NF” refers to nickel foam surface-treated with sulfuric acid, “HNO₃ “treated NF” refers to nickel foam surface-treated with nitric acid, and “Bare NF” refers to nickel foam not surface-treated with the sulfuric acid or nitric acid.

As shown in FIG. 10, it can be confirmed that the nickel foam before surface treatment had hydrophilicity (contact angle: 45.8 degrees), while all of the nickel foams treated with sulfuric acid (contact angle: 90.5 degrees) and nitric acid (contact angle: 82.8 degrees) had relatively high hydrophobicity due to reduction in the surface oxygen layer.

The dispersion degree of the nickel nanoclusters in the electrode was significantly increased due to the hydrophobic-hydrophobic interaction between the nickel foam that was changed to hydrophobic and the ligand of the nickel nanoclusters.

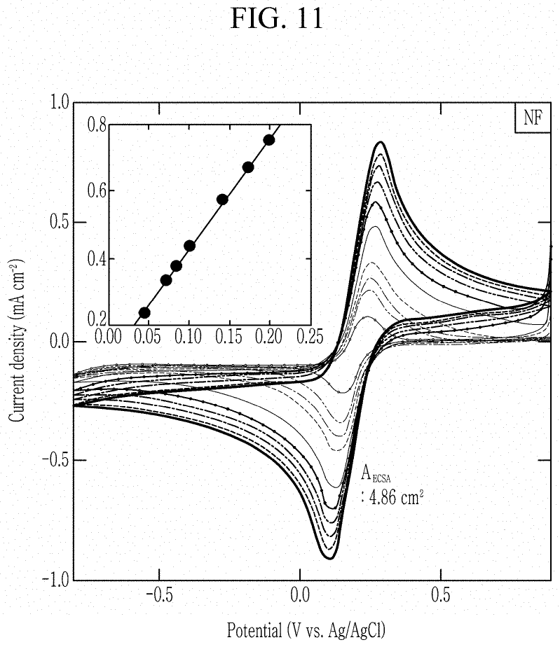

In addition, the electrochemical surface area (A_{ECSA}) of the surface-treated nickel foam was measured by a ferrocene circulating current method, and the results are shown in FIG. 11.

As shown in FIG. 11, it can be confirmed that the ratio of the A_{ECSA} with respect to a geometrical area (A_{geo}) of the nickel foam was 4.86.

### Experimental Example 3: Characteristic Measurement of Electrode for Oxygen Evolving

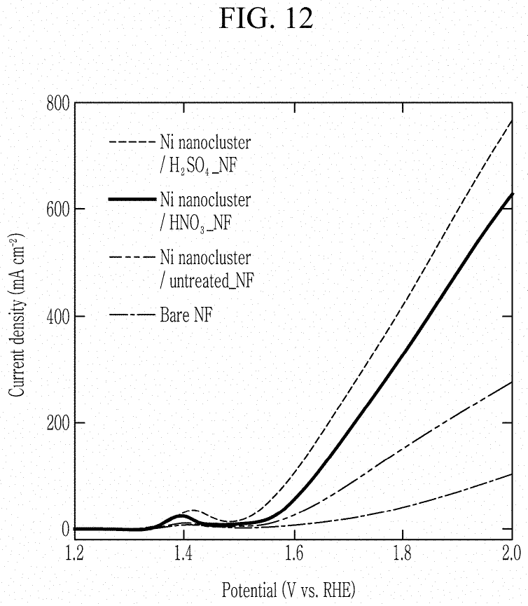

The oxygen generating activity of the electrode prepared by fixing the nickel nanoclusters to each of the nickel foam (H₂SO₄_NF, HNO₃_NF) surface-treated with sulfuric acid and nitric acid and the nickel foam (untreated_NF) not surface-treated, and the stability during the oxygen generation, were measured by a cyclic current method and a constant voltage method, and the results are shown in FIG. 12 to FIG. 14, respectively. The activity of the oxygen evolving was measured at 1.0 M KOH (pH 14).

As shown in FIG. 12, in a case of Ni₅(SC₂H₄Ph)₁₀/nickel foam (nitric acid surface treatment), a starting voltage was 1.50 V, and an achieved voltage of 200 mA·cm⁻² was 1.70 V. In a case of Ni₅(SC₂H₄Ph)₁₀/nickel foam (sulfuric acid surface treatment), a starting voltage was 1.50 V, and an achieved voltage of 200 mA·cm⁻² was 1.65 V.

Both electrodes had the activity of the oxygen evolving increased by about 5 times or more compared to nickel foam (Bare NF) in which Ni₅(SC₂H₄Ph)₁₀ did not exist, and had the activity of the oxygen evolving increased by about 2 times or more compared to the Ni₅(SC₂H₄Ph)₁₀/nickel foam electrode which was not surface treated (based on current density at 1.70 V).

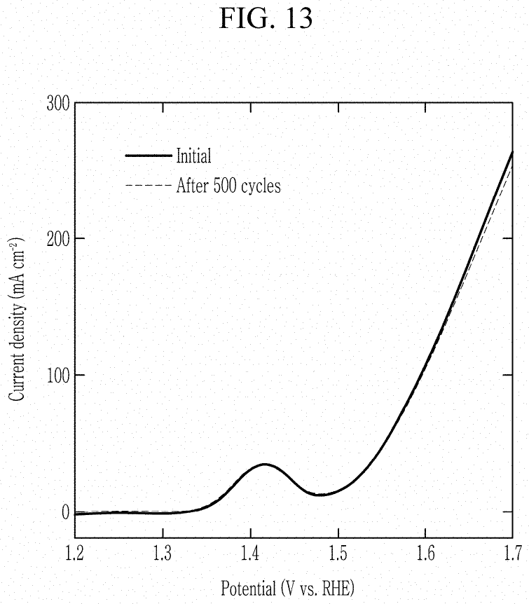

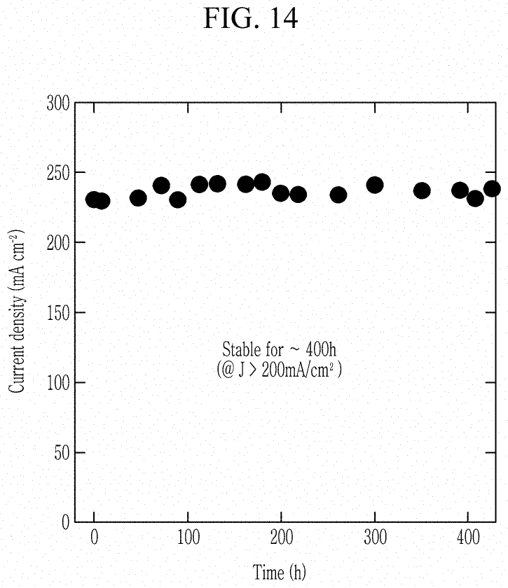

As shown in FIG. 13 and FIG. 14, Ni₅(SC₂H₄Ph)₁₀/nickel foam (sulfuric acid surface treatment) had high stability of the oxygen evolving of 500 cycles or greater when measured by the cyclic current method, and had high stability of the oxygen evolving of 400 hours or more when measured by the constant voltage method at the current density of 200 mA·cm⁻² or greater.

Meanwhile, as a result of confirming the stability during the oxygen evolving of the Ni₅(SC₂H₄Ph)₁₀/carbon electrode, in the experiment of the cyclic current method of 200 cycles or more, it was confirmed that corrosion occurred in the electrode and thus the oxygen generating activity was rapidly decreased.

### Experimental Example 4: Surface Area of Electrode for Oxygen Evolving

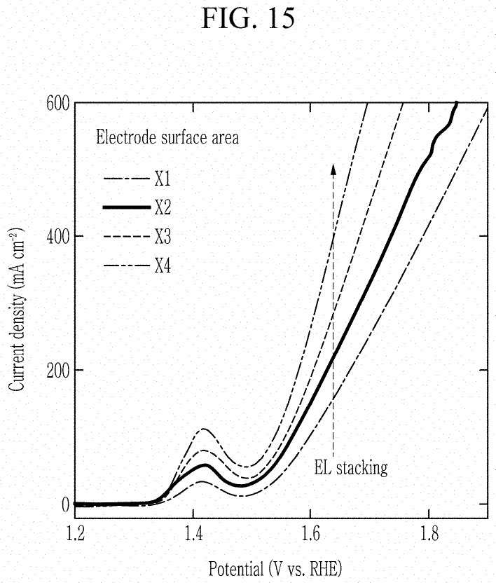

The electrode for the oxygen evolving having a thickness of 1.6 mm prepared in Preparation Example 2 was compressed to a thickness of 1.0 mm or less, the surface area thereof was increased to 1, 2, 3, and 4 times, respectively, the oxygen generating activity was measured for each of them, and the results are shown in FIG. 15.

As shown in FIG. 15, the Ni₅(SC₂H₄Ph)₁₀/nickel foam (sulfuric acid surface treatment) electrode whose surface area was increased by 4 times by compression had the oxygen generating activity of 200 mA·cm⁻² achieved voltage of 1.57 V, 280 mA·cm⁻² @ 1.60 V, and a 400 mA·cm⁻² achieved voltage of 1.63 V.

### Experimental Example 5: Optimization of Oxygen Generating Device

An oxygen generating device having the structure shown in FIG. 4 was manufactured using the electrode for the oxygen evolving prepared in Preparation Example 2.

In this case, in order to minimize the resistance of the aqueous solution electrolyte Rₛ, a distance W between the working electrode and the reference electrode was minimized (2 mm), and a distance C between the counter electrode and the reference electrode was set to 10 mm.

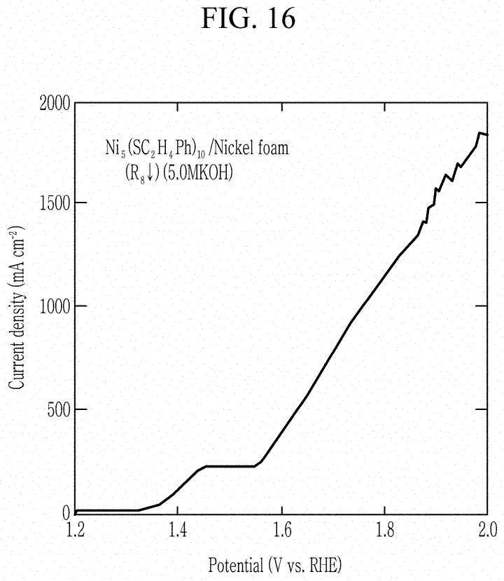

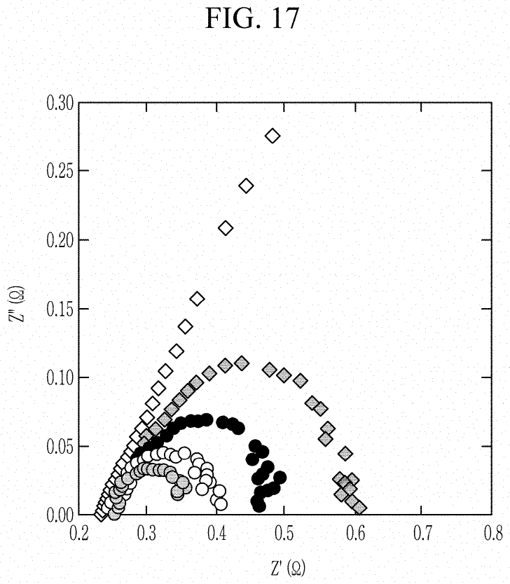

In this case, the oxygen generating activity of the electrode for the oxygen evolving, the charge transfer resistance R_{ct} of the electrode for the oxygen evolving, and the resistance Rₛ of the electrolyte were confirmed by electrochemical impedance spectroscopy (EIS), and the results are shown in FIG. 16 and FIG. 17, respectively.

As shown in FIG. 16 and FIG. 17, upon R_{S} minimization, the oxygen generating activity of the Ni₅(SC₂H₄Ph)₁₀/nickel foam (sulfuric acid surface treatment) electrode (x4) was confirmed to be an initial voltage of 1.50 V, 400 mA·cm⁻² @ 1.60 V, and at this time, the resistance Rₛ of the electrolyte was 0.25Ω.

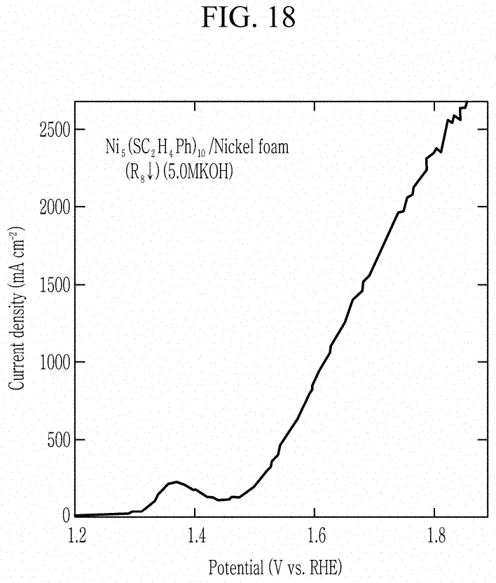

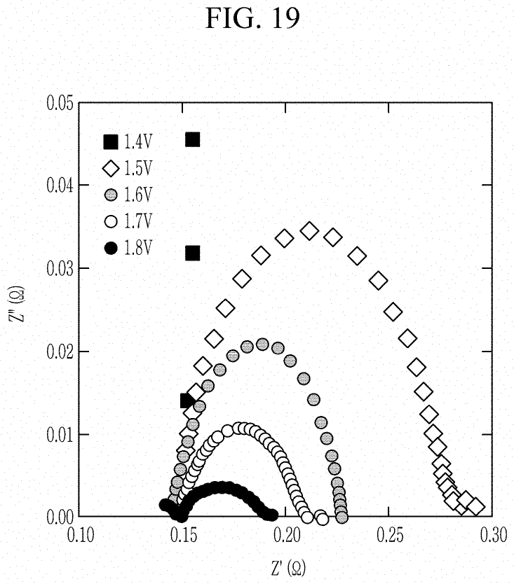

To further minimize the resistance Rₛ of the electrolyte, the distance between the working electrode and the reference electrode was fixed at 2 mm, and then the concentration of the electrolyte was increased from 1.0 M to 5.0 M. In this case, the charge transfer resistance R_{ct} of the electrode for the oxygen evolving and the resistance Rₛ of the electrolyte were also confirmed through EIS, and the results are shown in FIG. 18 and FIG. 19.

As shown in FIG. 18 and FIG. 19, Rₛ was confirmed to decrease to 0.15Ω, and the oxygen generating activity of the Ni₅(SC₂H₄Ph)₁₀/nickel foam (sulfuric acid surface treatment) electrode (x4) at 5.0 M was the starting voltage of 1.50 V, 840 mA·cm⁻² @ 1.60 V.

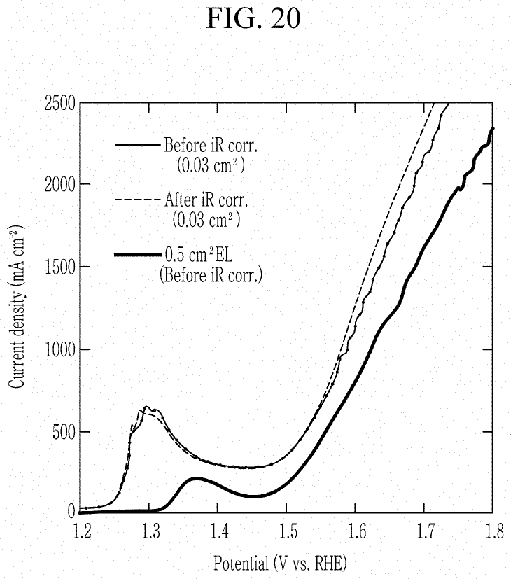

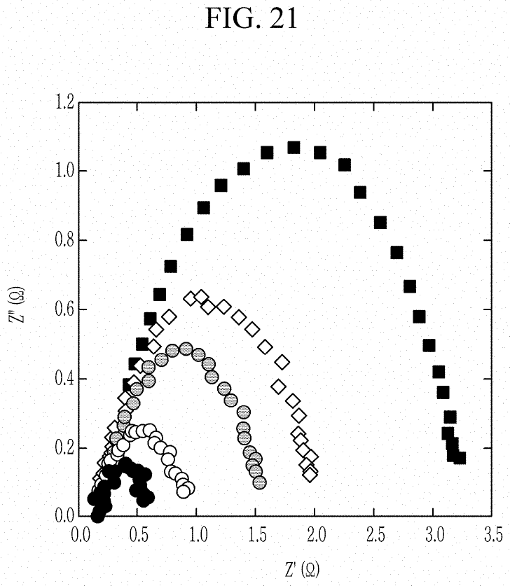

To minimize a corrected iR effect, the electrode area was reduced from 0.5 cm² to 0.03 cm². In this case, the charge transfer resistance R_{ct} of the electrode for the oxygen evolving and the resistance Rₛ of the electrolyte were also confirmed through EIS, and the results are shown in FIG. 20 and FIG. 21.

As shown in FIG. 20 and FIG. 21, the oxygen generating activity of the Ni₅(SC₂H₄Ph)₁₀/nickel foam (sulfuric acid surface treatment) electrode (x4, 0.03 cm²) at 5.0 M was the starting voltage of 1.48 V, 1100 mA·cm⁻² @ 1.60 V before iR correction, and was the starting voltage of 1.48 V, 1300 mA·cm⁻² @ 1.60 V after iR correction. This is the world's highest level of oxygen evolving activity.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10: oxygen generating device
11: container
12: aqueous solution electrolyte

What is claimed is:

1. An electrode for oxygen evolving, comprising:
a metal nanocluster comprising i) a core comprising metal atoms and ii) an organic thiol-containing ligand bound to a surface of the core; and
a metal support to which the metal nanocluster is fixed.

2. The electrode of claim 1, wherein the metal nanocluster is represented by Chemical Formula 1 below:
Niₙ(SR)₂ₙ [Chemical Formula 1]
in Chemical Formula 1,
R is one or more selected from the group consisting of a substituted or unsubstituted C1 to C24 aliphatic hydrocarbon group, and a substituted or unsubstituted C6 to C20 aromatic hydrocarbon group, and
n is an integer of 4 to 12.

3. The electrode of claim 2, wherein the metal nanocluster comprises one or more selected from a group consisting of Ni₄(SC₂H₄Ph)₈, Ni₅(SC₂H₄Ph)₁₀, Ni₆(SC₂H₄Ph)₁₂, Ni₄(SC₂H₅)₈, Ni₅(SC₂H₅)₁₀, Ni₆(SC₂H₅)₁₂, Ni₉(SPh)₁₈, Niₙ(SPh)₂₂, Ni₁₀(StBu)₁₀(etet)₁₀, Ni₁₂(StBu)₁₂(etet)₁₂, and a combination thereof,
wherein Ph is phenyl, StBu is tert-butyl thiolate, and etet is 2-ethylthioethanethiolate.

4. The electrode of claim 1, wherein the metal support comprises a nickel foam.

5. The electrode of claim 1, wherein the metal support is acid-etched to remove an oxide of a surface thereof.

6. The electrode of claim 1, wherein the electrode comprises a compressed body in which the metal support to which the metal nanocluster is fixed is compressed to a thickness of about 1.0 mm or less.

7. A method of preparing an electrode for oxygen evolving, comprising:
preparing a metal nanocluster comprising a core formed of metal atoms and an organic thiol-containing ligand bound to a surface of the core; and
fixing the metal nanocluster to a metal support.

8. The method of claim 7, further comprising removing a surface oxygen layer of the metal support by acid etching the metal support.

9. The method of claim 8, wherein the acid comprises sulfuric acid, nitric acid, or a mixture thereof.

10. The method of claim 8, wherein a concentration of the acid is about 3 M or greater, and an acid etching treatment time is within about 3 minutes.

11. The method of claim 8, wherein the metal support after the acid etching treatment has a hydrophobicity in which a contact angle thereof is increased by about 10% to 50% compared to that of the metal support before the acid etching treatment.

12. The method of claim 7, further comprising compressing the metal support to which the metal nanocluster is fixed, wherein the compressed metal support has a thickness of about 1.0 mm or less.

13. An oxygen generating device, comprising:
a working electrode including an electrode of claim 1;
a counter electrode; and
an aqueous solution electrolyte.

14. The oxygen generating device of claim 13, further comprising:
a reference electrode,
wherein a distance between the working electrode and the reference electrode is about 2 mm to 5 mm.

15. The oxygen generating device of claim 13, wherein a concentration of the aqueous solution electrolyte is about 1.0 M to 3.0 M.

16. The oxygen generating device of claim 13, wherein an area of the working electrode is about 0.03 cm² to 0.5 cm².
